(19) United States
(12) Patent Application Publication
(10) Pub. No.: US 2010/0043268 A1
(43) Pub. Date: Feb. 25, 2010

(54) RELATING TO PICTURE FRAMES

(75) Inventor: Robin Leighlon Powell, Howick (NZ)

Correspondence Address: YOUNG & THOMPSON, 209 Madison Street, Suite 500, Alexandria, VA, 22314, US

(73) Assignee: Robindo Limited, Auckland (NZ)

(21) Appl. No.: 12/519,231

(22) PCT Filed: Nov. 20, 2007
(86) PCT No.: PCT/NZ07/00342

§ 371 Date: Jun. 15, 2009

(30) Foreign Application Priority Data
Dec. 13, 2006 (NZ) 552069

(51) Int. Cl. A47G 1/08; A47G 1/10; B23P 11/00

(52) U.S. Cl. 40/741; 40/783; 40/785; 29/525.01

(57) ABSTRACT

Disclosed are a device, method, and kit relating to frames, particularly, although not exclusively, to a kit for assembling a frame for mounting art work, photographs, certificates or the like. There is provided a frame for framing an object, the frame including: joint frame members for each frame which are configured to receive two side frame members, and side frame members; and characterized in that the side frame members are substantially the same length as the object to be framed, and each joint frame member is adapted so that once the side frame members are received by the joint frame member, the side frame members extend from the joint frame member at a predetermined angle.

### STATEMENT OF CORRESPONDING APPLICATIONS

This application is based on the Provisional specification filed in relation to New Zealand Patent Application Number 552069, the entire contents of which are incorporated herein by reference.

### TECHNICAL FIELD

The present invention relates to improvements in and relating to frames. Particularly, although not exclusively, the present invention relates to a kit for assembling a frame for mounting art work, photographs, certificates or the like.

### BACKGROUND ART

Frames employed for picture and photographic type framing are often manufactured from separate frame elements that are joined together via mitre joints and hence this type of frame is often referred to as a mitred frame. A mitre joint requires a high degree of precision not only in marking out the required angle and length of frame side elements but also with cutting and subsequent assembly of the joint; otherwise any discrepancy is at once apparent.

A mitred joint for a four sided frame requires a precise 45° angle to be cut. Failure to cut the frame elements at precisely the required angle causes the side frame members to not form a flush joint which can result in unsightly gaps in the joint.

Consequently production of mitred frame requires a high degree of skill and can be difficult for an unskilled person to achieve.

A mitre joint is usually butted and consequently needs a support structure. Otherwise the butted frame must be fixed from the rear to a stable rectangular frame.

The latter construction is used for the construction of wood frames. However, for metal frames the mitred parts are instead grooved continuously around the outer edge and four machined L-shaped aluminium corner braces are screwed into the groove with self tapping screws. Adaptation for display work involves releasing two corners, sliding into the groove a pair of tube embracing plastic grips, refitting both corners and snapping the grips onto the tube.

An alternative to mitred frame corners are preformed joint frame members to which side frame members can be attached, see for example New Zealand Patent Application No. 235023 which discloses such a framing system.

FIG. 1 illustrates a prior art joint and frame assembly disclosed in the specification of New Zealand Patent No. 235023 and made up of a joint frame member 10 into which an end of side frame member 12 is inserted.

However, the disadvantage of the assembly disclosed in NZ 235023 is that it requires assembly of the two piece joint frame members about the side frame members which can be inconvenient and requires the side frame members to be of the correct length so that aperture A on the joint frame member 10 can receive the side frame member 12 and hold an object to be framed in place. In addition the sizing of the side frame members 12 needs to be accurate to take into account the length of one side of the joint frame member 10 so that the length of the side frame member 12 is less than the corresponding side length of the object to be framed.

Therefore it would be an advantage for there to be a kit which would enable an unskilled person to assemble a frame without undue experimentation and inconvenience.

Although one or more prior art publications are referred to herein, this reference does not constitute an admission that any of these documents form part of the common general knowledge in the art, in New Zealand or in any other country.

All references, including any patents or patent applications, cited in this specification are hereby incorporated by reference. No admission is made that any reference constititutes prior art. The discussion of the reference states what their authors assert, and the applicants reserve the right to challenge the accuracy and pertiency of the cited documents. It will be clearly understood that, although a number of prior art publications are referred to herein, this reference does not constitute an admission that any of these documents forms parts of the common general knowledge in the art, in New Zealand or in any other country.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a frame for framing an object, said frame including:
joint frame members for each frame which are configured to receive two side frame members, and
side frame members; and
   characterised in that the side frame members are substantially the same length as the object to be framed, and
   each joint frame member is adapted so that once the side frame members are received by the joint frame member, the side frame members extend from the joint frame member at a predetermined angle.

Preferably, each joint frame member may include at least two fascia portions which in use extend over the ends of the side frame members attached to the joint frame member.

Preferably, the joint frame member may include a body and at least two fascia portions extending there from which overlaps with the top surface of the side frame members received by the joint frame member.

Preferably, the width of the fascia portions may be at least the width of the end of the side frame members.

Preferably, each side frame member may be configured with markings on at least one side of said side frame member.

Preferably, the markings may be lines; colours; pre-scored markings; patterns at various angles and intervals along the side frame member.

Preferably, the markings may be pre-scored markings enabling the side frame member to be sectioned at one of the markings to a required length.

Preferably, the side frame members may be adapted to receive the edge of the object to be framed.

Preferably, the side frame members may be adapted to receive the edge or portion of the object to be framed.

Preferably, the body of the joint frame member may include at least one groove, slot, projection or hole into which a side frame member is received via a corresponding groove, slot, projection or hole.

Preferably, the joint frame member may retain the side frame members together.

Preferably, the frame may further include at least one retaining means to contact the side frame member and the object to be framed and retain said object inside the frame.

Preferably, the retaining means may be a clip made of a resilient material.

Preferably, the frame may include at least one fastening means to fasten the joint frame member to the side frame member after said joint frame member is attached with said side frame member.

Preferably, the fastening means may be a screw, nail or pin which passes through the joint frame member into the side frame member.

Preferably, the frame may be sold as a kitset including:
a single length of side frame member material;
a plurality of joint frame members;
a plurality of retaining means, and
a plurality of fastening means.

According to another aspect of the present invention there is provided a method including the steps of:
a forming side frame members in lengths substantially the same as the lengths of the corresponding sides of the object to be framed;
locating the side frame members inside a joint frame member;
locating the object to be framed inside the assembled frame, and
retaining the said object inside the frame with at least one retaining means.

Preferably, the side frame members may be formed by cutting or snapping at markings on said side frame members.

Preferably, the method may include the additional step of fastening the located side frame members inside a joint frame member with at least one fastening means.

### BRIEF DESCRIPTION OF DRAWINGS

Further aspects of the present invention will become apparent from the ensuing description which is given by way of example only and with reference to the accompanying drawings in which:

FIG. 1 shows a framing system as disclosed in New Zealand Patent Application No. 235023;

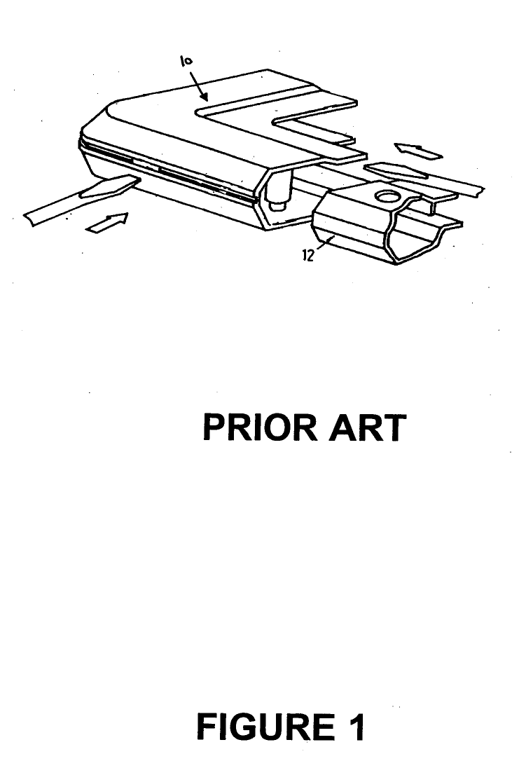

FIG. 2 shows an exploded perspective view of a frame of the present invention;

FIG. 3 shows a sectional view of the joint frame member of the embodiment shown in FIG. 2 with two side frame members attached;

FIG. 4 shows an exploded perspective view of a joint frame member of the embodiment shown in FIG. 2 with two side frame members and two fastening means, and

FIG. 5 shows a sectional view of the side frame member of the embodiment shown in FIG. 2;

FIG. 6 shows a perspective view of the joint frame member of the embodiment shown in FIG. 2 with two side frame members attached and a retaining means retaining an object with the frame;

FIG. 7 shows a sectional view of a side frame member of the embodiment shown in FIG. 2 retained on an object with a retaining means;

FIG. 8 shows a perspective view of an alternative embodiment of a joint frame member of the present invention attached to two side frame members, and

FIG. 9 shows the underside of a length of side frame member with pre-scored markings.

### BEST MODES FOR CARRYING OUT THE INVENTION

The present invention provides a system of forming a frame which can be completed by a person not necessarily skilled in the art of framing.

The frame of the present invention maybe used for picture or photographic framing. However, this should not be seen as limiting and could also be used for paneling; shelving; sales displays; shop-fitting; plinths; enclosures; point of sale aids; structures for exhibitions; mirrors; stage sets; signage; window and door frames; certificates; or the like.

Throughout the present specification the term ‘joint frame member’ should be understood to mean a component for joining together two side frame members.

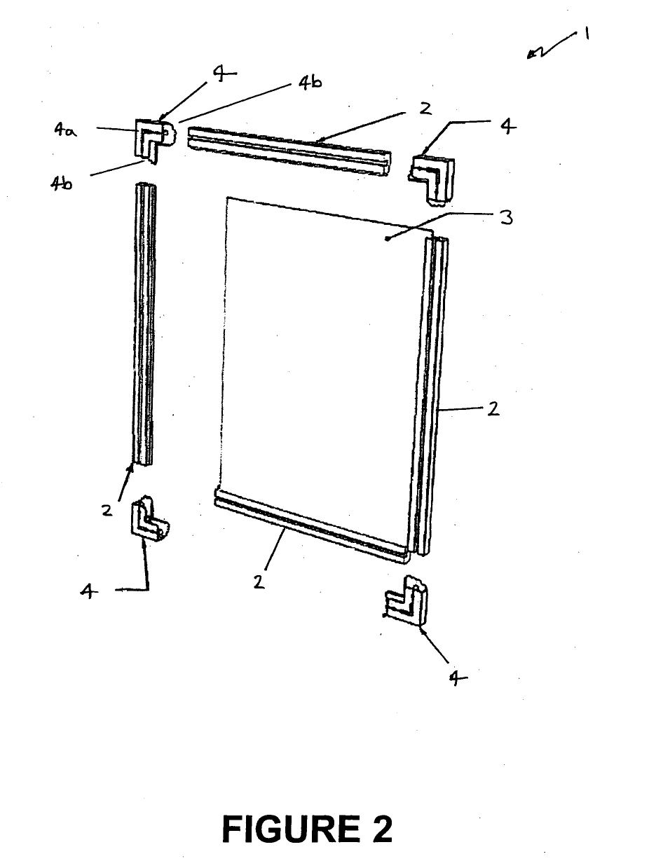

The invention is now described in relation to the preferred embodiments of the present invention as shown in FIGS. 2 to 9. It should be appreciated the invention may be varied from the figures without departing the scope of the invention.

Referring to FIGS. 2 to 9, there is shown a frame generally indicated by arrow 1. The frame 1 includes a plurality of side frame members 2 the number of which corresponds to the number of sides of the object 3 to be framed, such as a picture canvas. These side frame members 2 may then comprise either the top, bottom or side frame members 2. In addition the frame 1 includes an equal number of joint frame members 4. These joint frame members 4 are configured to receive and retain side frame members 2 at the required angle and to cover discrepancies in the cut edge of the side frame members 2.

Each side frame member 2 is of any shape such as L-shaped; flat; square; round; convex or concave and the joint frame member 4 is a corner piece of any profile that complements a corresponding side frame member such as L-shaped; flat; square; round; convex and concave.

The side frame member 2 and joint frame member 4 are made of a rigid material such as plastic; ceramic; fibreglass; rubber; metal; wood; composite material; paper; cardboard.

Each joint frame member 4 in the form of an L-shaped profile is attached to two side frame members 2. Each joint frame member 4 has a body portion 4a and two openings in the form of fascia portions 4b which are adapted to accommodate the side frame members 2 to be engaged in each opening 4b of the joint frame member 4.

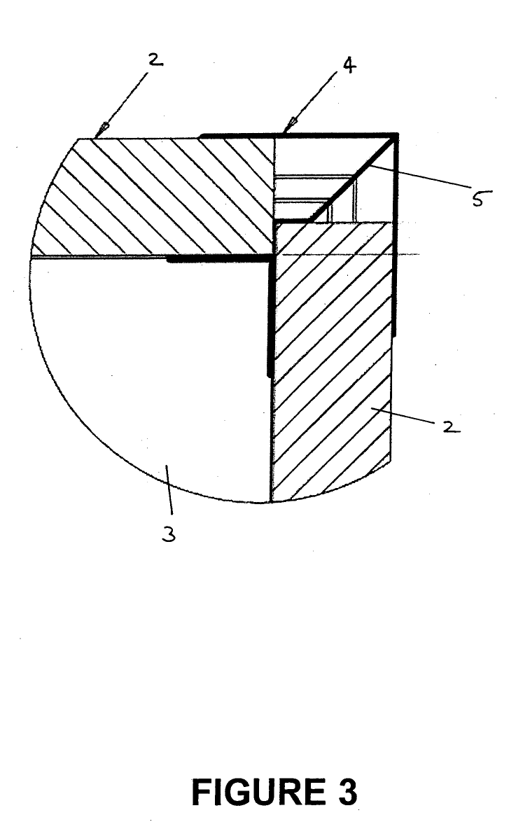

FIG. 3 shows a sectional view of one of the joint frame members 4 with side frame members 2 installed. The joint frame member 4 includes a mounting 5 which allows for overlap of the two opposing side frame members 2 cut with a square end and to the same length as the corresponding side of the object 3 to form a symmetric join. The inserted side frame members 2 abut substantially perpendicular to each other in the joint frame member 4 at a substantially 90° angle by virtue of the angle of the fascia portions 4b to form a frame 1 with four sides.

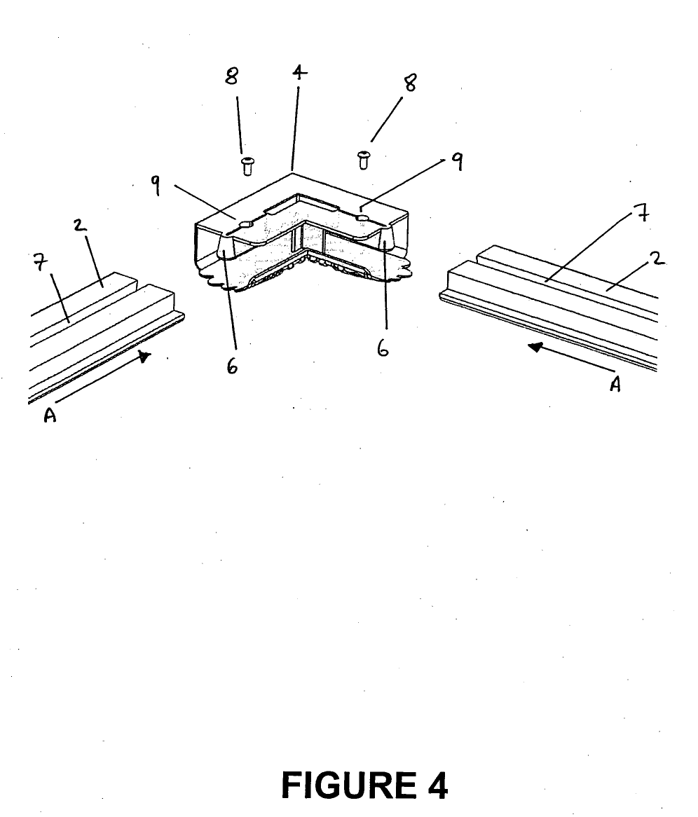

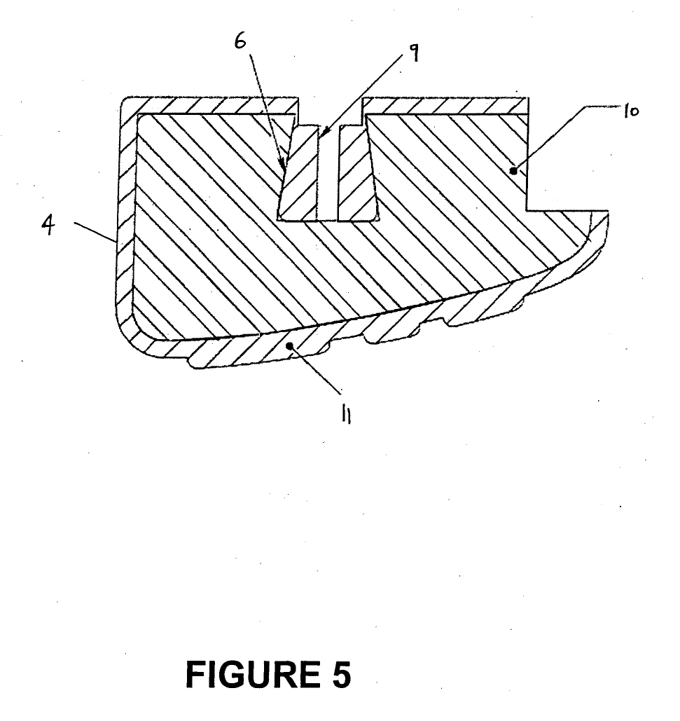

FIGS. 4 and 5 show two side frame members 2 inserted into joint frame member 4 in the direction of arrow A. A dovetail projection 6 in each arm of the L-shaped profile of the joint frame member 4 engages with a corresponding recess in the form of a channel 7 running the length of the side frame member 2.

Fastening of the inserted side frame members 2 in the joint frame member 4 may be made by inserting a fastening means 8 in the form of a flat head screw through aperture 9 into the dovetail projection 6 of the joint frame member 4 which causes the dovetail projection 6 to splay and engage with the channel 7 of the inserted side frame member 2 and thereby fasten the joint frame member 4 to the side frame member 2.

A recess 10 in the side frame member 2 accepts the edge of the object 3 to be framed. Decoration in the form of profiling on the outer surface 11 of the side frame member 2 adds visual appeal to the side frame member 2.

In this way, the fascia portions 4b extend over the ends of the side frame members 2 a sufficient extent to cover discrepancies in the cut angle of the side frame members 2.

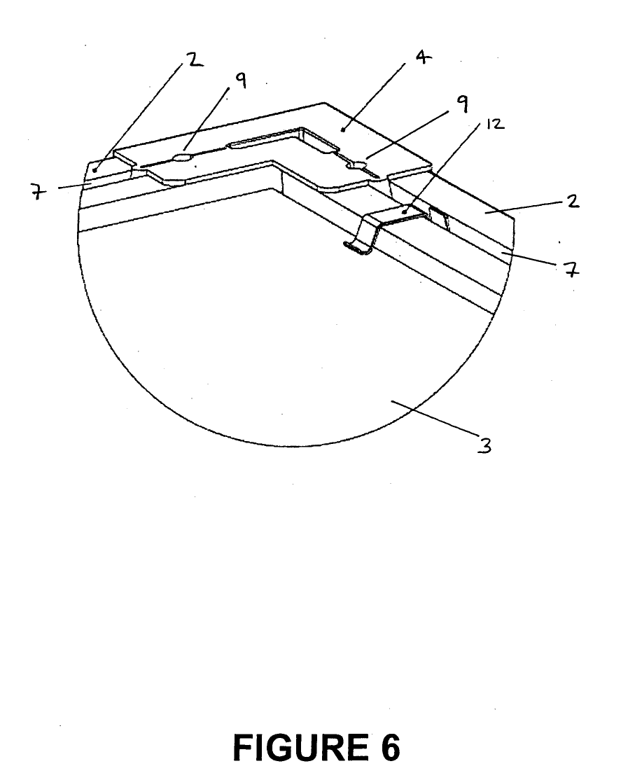

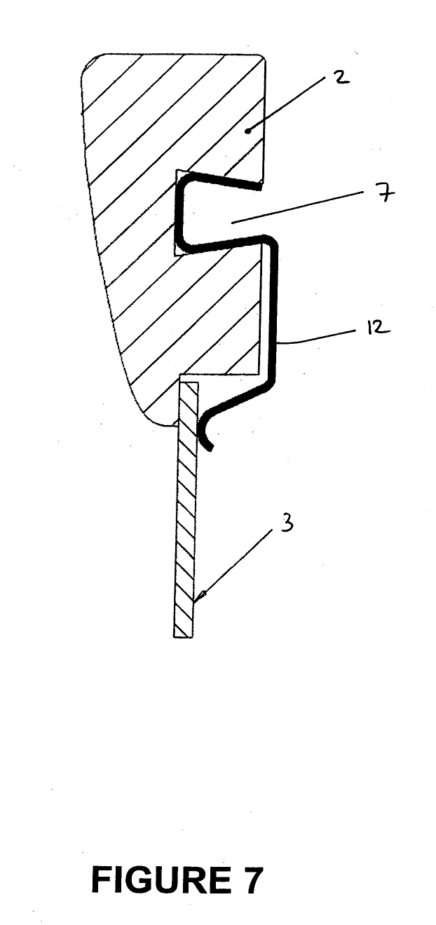

FIGS. 6 and 7 show a retaining means 12 in the form of a clip is located into the channel 7 in the side frame member and contacts the object 3 thereby securing the object 3 and optionally a protective cover (not shown) within the frame 1. However, this should not be seen as a limitation on the embodiments for this invention. Other types of retaining means such as clamps known in the industry may conceivably be used with this invention.

It is envisaged a method of assembling the frame 1, includes steps of:
forming side frame members 2 in lengths substantially the same as the lengths of the corresponding sides of the object 3 to be framed;
locating two side frame members 2 inside each joint frame member 4;
locating the object 3 to be framed inside the assembled frame 1, and
retaining the said object 3 inside the frame 1 with at least one retaining means 12.

It is envisaged the frame 1 of the present invention may be sold in a kitset which includes a single length of side frame member 2 so that the user may cut the required number of side frame members 2 from the single length of material.

The kitset may also contain all the necessary hardware such as joint frame members 4, a length of side frame member 2, transparent cover (made of glass, transparent acetate or the like) and retaining means 12 such as clips to retain the transparent cover and object 3 in the framed.

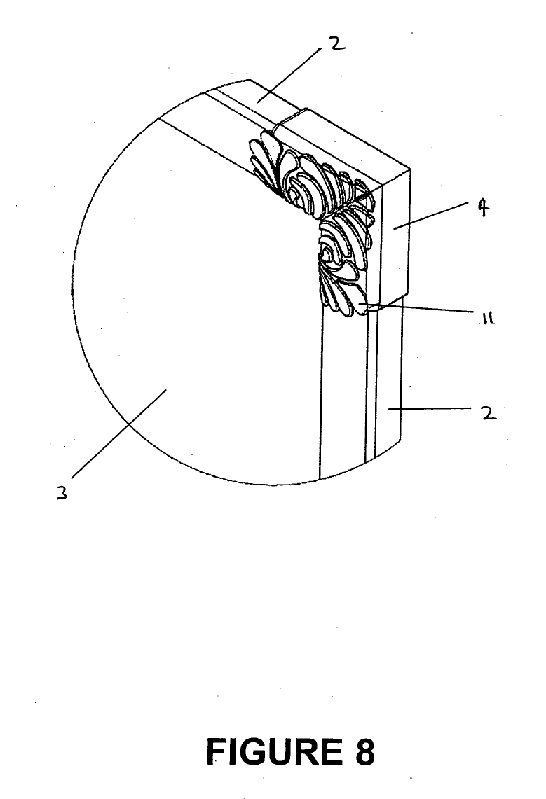

Referring to FIG. 8 the joint frame member 4 and side frame member 2 may be manufactured as moulded parts and have a variety of different configurations or designs such as a rounded cross section or triangular cross section.

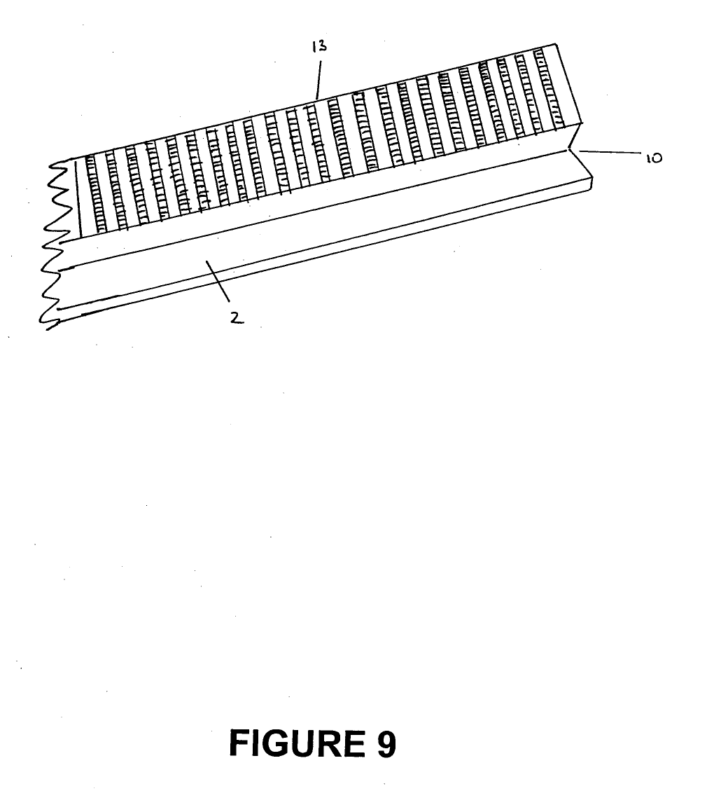

FIG. 9 shows a bottom view of a length of side frame member 2 with pre-scored markings 13 along the bottom side of the side frame member 2 at various predetermined intervals. In use the side frame member 2 is cut and/or snapped to the required lengths using the markings 13 at the required length interval and angle. In this way pre-scored markings 13 have the added advantage of providing support for a cutting tool to enable the user to accurately cut side frame member 2 at the required length and angle.

Thus, preferred embodiments of the present invention may have a number of advantages over the prior art which can include:
simplification of the procedure for forming a substantially symmetric frame to frame an object including aesthetically pleasing frame edges;
removal of the skill needed to mitre frame corners which can require specialist experience and equipment;
meeting the need for “DIY” picture frame assembly and at a reduced cost.

Aspects of the present invention have been described by way of example only and it should be appreciated that modifications and additions may be made thereto without departing from the scope thereof as defined in the appended claims.

1-19. (canceled)

20. A frame for framing a planar object, said frame including:
side frame members, and
joint frame members for each frame which are configured to receive two side frame members
characterized in that the side frame members are the same length as the edges of the planar object to be framed and have end edges substantially perpendicular to the side edges, and
each joint frame member is adapted so that once the side frame members are received by the joint frame member, the side frame members extend from the joint frame member at a predetermined angle.

21. A frame as claimed in claim 20 wherein each joint frame member includes at least two overlapping portions which in use extend over the ends of the side frame members attached to the joint frame member.

22. A frame as claimed in claim 20 wherein the joint frame member includes a body and at least two overlapping portions extending there from which overlaps with the top surface of the side frame members received by the joint frame member.

23. A frame as claimed in claim 22 wherein the width of the overlapping portions are at least the width of the end of the side frame members.

24. A frame as claimed in claim 20 wherein each side frame member is configured with markings on at least one side of said side frame member.

25. A frame as claimed in claim 24 wherein the markings are lines; colours; pre-scored markings; patterns at various angles and intervals along the side frame member.

26. A frame as claimed in claim 25 wherein the markings are pre-scored markings enabling the side frame member to be sectioned at one of the markings to a required length.

27. A frame as claimed in claim 20 wherein the side frame members are adapted to receive the edge of the planar object to be framed.

28. A frame as claimed in claim 27 wherein the side frame members are adapted to receive the edge or portion of the planar object to be framed.

29. A frame as claimed in claim 22 wherein the body of the joint frame member includes at least one groove, slot, projection or hole into which a side frame member is received via a corresponding groove, slot, projection or hole.

30. A frame as claimed in claim 20 wherein the joint frame member also includes a mounting to abut a portion of the end edges of two side frame members, once the side frame members have been received by the joint frame member, to provide for overlap of the two side frame members with respect to one another.

31. A frame as claimed in claim 20, the frame further including at least one retaining means to contact the side frame member and the planar object to be framed and retain said planar object inside the frame.

32. A frame as claimed in claim 31 wherein the retaining means is a clip made of a resilient material.

33. A frame as claimed in claim 20 wherein the frame includes at least one fastening means to fasten the joint frame member to the side frame member after said joint frame member is attached with said side frame member.

34. A frame as claimed in claim 33 wherein the fastening means is a screw, nail, or pin which passes through the joint frame member into the side frame member.

35. A method of framing a planar object, said method including the steps of:
forming side frame members in lengths the same as the edges of the planar object to be framed with end edges substantially perpendicular to the side edges;
locating the side frame members inside a joint frame member;
locating the planar object to be framed inside the assembled frame, and
retaining the said planar object inside the frame with at least one retaining means.

36. A method of framing an object as claimed in claim wherein the side frame members are formed by cutting or snapping at markings on said side frame members.

37. A method of framing a planar object as claimed in claim 34 which includes the additional step of fastening the located side frame members inside a joint frame member with at least one fastening means.

38. A kitset of parts for a frame as claimed in claim 33, said kitset including:
a single length of side frame member material,
a plurality of joint frame members,
a plurality of retaining means, and
a plurality of fastening means.
